(19) United States
(12) Patent Application Publication
(10) Pub. No.: US 2011/0080402 A1
(43) Pub. Date: Apr. 7, 2011

(54) Method of Localizing Landmark Points in Images

(76) Inventors: Karl Netzell, Lund (SE); Jan Erik Solem, Bjarred (SE)

(21) Appl. No.: 12/573,165

(22) Filed: Oct. 5, 2009

(51) Int. Cl. G06T 17/00

(52) U.S. Cl. 345/420

(57) ABSTRACT

A method of localizing landmark points and fitting appearance based models to image data. Image products are computed efficiently which improves the computational cost and improves performance of fitting algorithms for such models.

### BACKGROUND OF THE INVENTION

Here, relevant background material is presented and the relation to prior art explained. The technical details of the invention is presented in the following section Detailed Description and in the research paper [?].

Shape and appearance models can be applied to solve many different problems either by using the fitted model itself or using the model to locate landmark points in images. The most successful applications to this day are the analysis of medical images and images of faces, cf. e.g. [?] for examples. Early work like e.g. the active shape models [?] modeled only the variations in shape. This work was later extended so that the models also include the variations of the appearance (i.e. the image color) as well as the shape, the active appearance models [?] (AAM).

The building of such a model is done offline on a training set of annotated objects. In the online event of a new image containing an object of the modeled category, the model parameters have to be found by fitting the model to the image data. It is in this part that the contribution of the invention lies, by proposing an algorithm that drastically improves the computational cost of this fitting. There are several methods to chose from when performing this fitting. Many of them, most notably the robust simultaneous inverse compositional algorithm introduced in [?], involves the computation of a hessian matrix at each step of the optimization.

In the following section the invention, a way to speed up the computation of certain types of image inner products where the images are in a linear space, is introduced. This type of inner product is used e.g. in the computation of the hessian mentioned above. The computation of this hessian is the most expensive step of this iterative procedure and therefore the invention has considerable impact in reducing the computational load of systems and applications for image analysis and recognition. Under normal model assumptions the difference is a factor 9 to a factor 650 for the hessian computation and a factor 3 to a factor 7 of the actual model fitting, depending on image size.

The issue of computational efficiency has been addressed previously in the literature, see for instance [?]. The efficiency enhancement described in this reference is only achieved at a considerable loss in fitting performance [?]. The present invention gives a similar speedup, while maintaining fitting accuracy.

### BRIEF DESCRIPTION OF DRAWINGS

FIG. 1 shows an example of a shape and appearance representation for a face model, including landmark points.

FIG. 2 shows an example of a system or device for obtaining images, analyzing, and responding to results from the landmark localization.

### ACTIVE APPEARANCE MODELS

Active appearance models (AAMs) [?, ?] are linear shape and appearance models that model a specific visual phenomenon. AAMs have successfully been applied to face modeling with applications such as face synthesis, face recognition [?, ?] and even facial action recognition [?] and medical image analysis with application such as diagnostics and aiding measurement.

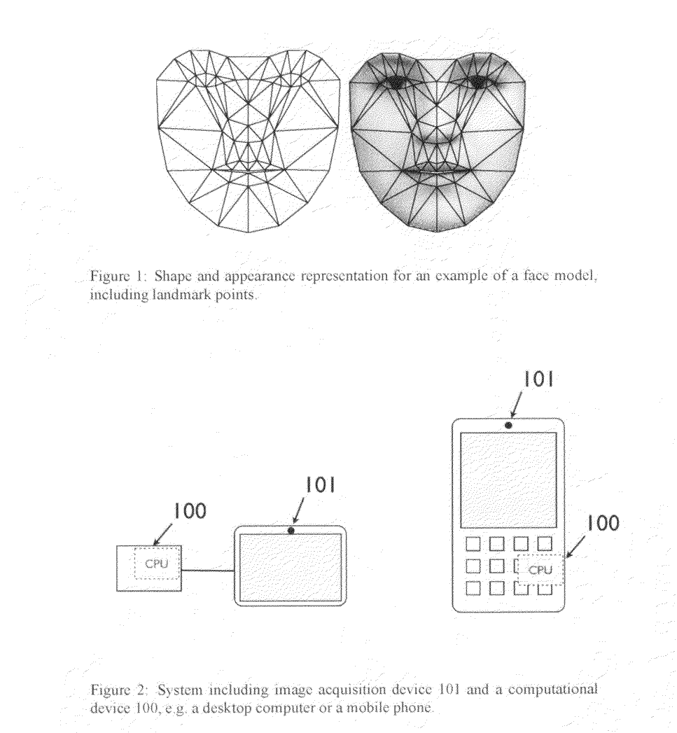

In the AAM framework the shape is modeled as a base shape s₀ with a linear combination of shape modes Sᵢ as

$$S = {S}_{0} + {\sum }_{i = 1}^{m} {p}_{i} {s}_{i} , \qquad ( 1 )$$

where pᵢ are the shape coefficients and the shape s is represented as the 2D coordinates of the v vertices of a model mesh as S=(x₁, y₁, . . . , xᵥ, yᵥ), cf. FIG. 1. We will use p to denote the vector of pᵢ.

The appearance is modeled completely analogous as a base appearance image A₀ together with a linear combination of appearance modes Aᵢ as

$$A = {A}_{0} + {\sum }_{i = 1}^{n} {λ}_{i} {A}_{i} , \qquad ( 2 )$$

where λᵢ are the appearance coefficients and an appearance image is given by the set of pixels inside the same model mesh as above. We will use λ to denote the vector of λᵢ. The shape and appearance modes are found using Principal Component Analysis (PCA) on aligned training data.

To be able to fit a model instance into an image additional parameters q are needed to describe scaling, rotation and translation. Setting

$$r = ( \begin{matrix}q \\ p\end{matrix} ) ,$$

the warp W(r) is the piecewise affine warp from the base mesh S₀ to the current AAM shape under r. Thus I(W(r)) is an image on S₀ in which the pixel intensities are taken from the image I according to the warp W(r).

Simultaneous Inverse Compositional Image Alignment Algorithm

The simultaneous inverse compositional image alignment algorithm (SICIA) [?] is an algorithm for fitting the AAM to an input image I simultaneously with regards to appearance and shape. Inverse compositional signifies how the warp parameters r are updated.

The overall goal of the algorithm is to minimize the difference between the synthesized image of the model and the image I as

$${[ {\sum }_{i = 0}^{n} {λ}_{i} {A}_{i} - I ( W ( r ) ) ]}^{2} , \qquad ( 3 )$$

where λ₀=1 (note the summation limits). In the inverse compositional formulation the minimization of equation (3) is carried out by iteratively minimizing

$${[ {\sum }_{i = 0}^{n} ( {λ}_{i} + {Δλ}_{i} ) {A}_{i} ( W ( Δ r ) ) - I ( W ( r ) ) ]}^{2} \qquad ( 4 )$$

simultaneously with respect to both λ and r. Note that the update of the warp is calculated on s₀ and not on the present AAM instance. The new parameters rₖ₊₁ are then given as a composition of the warp update Δrₖ and the present rₖ so that

W(rₖ₊₁)←W(rₖ)∘W(Δrₖ)⁻¹. (5)

This means the gradient of the warp is constant [?]. The appearance parameters are updated by λₖ₊₁←λₖ+Δλₖ. Performing a first order Taylor expansion on expression (4) gives

$${[ E + ( {\sum }_{i = 0}^{n} {λ}_{i} ∇ {A}_{i} ) \frac{\partial W}{\partial r} Δ r + {\sum }_{i = 1}^{n} {A}_{i} {Δλ}_{i} ]}^{2} , \qquad ( 6 )$$

where the error image is

$$E = {\sum }_{i = 0}^{n} {λ}_{i} {A}_{i} - I ( W ( r ) ) . \qquad ( 7 )$$

For notational convenience set

$$t = ( \begin{matrix}r \\ λ\end{matrix} ) and Δ t = ( \begin{matrix}Δ r \\ Δλ\end{matrix} ) .$$

Also define the steepest descent images as

$${SD}_{Σ} = ( ( {\sum }_{i = 0}^{n} {λ}_{i} ∇ {A}_{i} ) \frac{\partial W}{\partial {r}_{1}} , … , ( {\sum }_{i = 0}^{n} {λ}_{i} ∇ {A}_{i} ) \frac{\partial W}{\partial {r}_{m + 4}} , {A}_{1} , … , {A}_{n} ) . \qquad ( 8 )$$

The +4 comes from the fact that in a 2D case one needs 4 parameters in q. Using these reformulations (6) can be expressed as

[E−SD_{Σ}Δt]², (9)

which is minimized by

Δt=−H⁻¹SD_{Σ}^{T}E, (10)

where the hessian is given by

H=SD_{Σ}^{T}SD_{Σ}. (11)

### DETAILED DESCRIPTION

In a preferred embodiment of the invention, a method for image model fitting and landmark localization is presented, the method comprising the steps of; —computation of the hessian matrix using the space defined by the image model to pre-compute the image inner products, —fitting the appearance model to image data, —storing the final model and landmark points for further use.

Yet another embodiment of the present invention, a computer program stored in a computer readable storage medium and executed in a computational unit for image model fitting and landmark localization comprising the steps of: —computation of the hessian matrix using the space defined by the image model to pre-compute the image inner products, —fitting the appearance model to image data, —storing the final model and landmark points for further use.

In another embodiment of the present invention, a system for image model fitting and landmark localization containing a computer program for image model fitting and landmark localization comprising the steps of: —computation of the hessian matrix using the space defined by the image model to pre-compute the image inner products, —fitting the appearance model to image data, —storing the final model and landmark points for further use.

In another embodiment of the present invention a system or device is used for obtaining images, analyzing, and responding to results from the landmark localization, as may be seen in FIG. 2. Such a system may include at least one image acquisition device 101 and a computational device 100.

The above mentioned and described embodiments are only given as examples and should not be limiting to the present invention. Other solutions, uses, objectives, and functions within the scope of the invention as claimed in the below described patent claims should be apparent for the person skilled in the art.

Below follows a detailed description of the invention.

Linear Space Inner Product

In this section we will detail a method of efficiently computing image inner products and show how this improves the computation of the hessian matrix in (11).

Formulating Inner Products using Linear Projections

Assume that the image I, represented as a vector, can be expressed as a linear combination of g appearance images Aᵢ just as in equation (2). The inner product I_{b}^{T}I_{c} of two such images I_{b} and I_{c} is an operation taking as many multiplications to complete as there are elements (pixels) in the vector (image). If we rewrite the inner product using the appearance image representation it becomes

$${\sum }_{i = 0}^{g} {\sum }_{j = 0}^{g} {λ}_{b , i} {λ}_{c , j} {a}_{i , j} \qquad ( 12 )$$

where the scalar a_{i,j}=Aᵢ^{T}Aⱼ. The computations of all a_{i,j} can be done offline since they are fixed once the appearance images Aᵢ are chosen. Assuming that we have obtained the coefficients λ_{b,i} and λ_{c,i} the inner product can be computed using 2g² multiplications instead of as many multiplications as there are pixels.

Linear Space Inner Product (LSIP) Applied to AAM

In one hessian calculation (n+m+4)² number of scalar products are performed while λ stay constant. This means that the hessian calculation is very suited to be performed using the LSIP.

Studying equations (8) and (11), one sees that the hessian will have four distinct areas computation-wise.

The Upper Left Quadrant.

Here each hessian element is given by

$${H}_{ij}^{ul} = {( ( {\sum }_{k = 0}^{n} {λ}_{k} ∇ {A}_{k} ) \frac{\partial W}{\partial {r}_{i}} )}^{T} ( ( {\sum }_{l = 0}^{n} {λ}_{l} ∇ {A}_{l} ) \frac{\partial W}{\partial {r}_{j}} ) , \qquad ( 13 )$$

with i,jε[1,m+4]. Analogously to Section 2(′)@ we rewrite

$${H}_{ij}^{ul} = {\sum }_{k = 0}^{n} {\sum }_{l = 0}^{n} {λ}_{k} {λ}_{l} {h}_{kl}^{ul , i , j} , \qquad ( 14 )$$

where

$${h}_{kl}^{ul , i , j} = {( ∇ {A}_{k} \frac{\partial W}{\partial {r}_{i}} )}^{T} ( ∇ {A}_{l} \frac{\partial W}{\partial {r}_{j}} ) .$$

Moving one multiplication outside and limiting the inner summation limit gives

$${H}_{ij}^{ul} = {\sum }_{k = 0}^{n} {\sum }_{l = k}^{n} {λ}_{kl} {h}_{kl}^{ul , i , j} , {λ}_{kl} = \{ \begin{matrix}{λ}_{k} {λ}_{l} & if i = j \\ 2 {λ}_{k} {λ}_{l} & if i \neq j .\end{matrix} \qquad ( 15 )$$

The Lower Left and Upper Right Quadrant.

The upper right and lower left quadrants are symmetrical and therefore only the upper right quadrant will be described. The hessian elements are given by

$${H}_{ij}^{ur} = {( ( {\sum }_{k = 0}^{n} {λ}_{k} ∇ {A}_{k} ) \frac{\partial W}{\partial {r}_{i}} )}^{T} {A}_{j} , \qquad ( 16 )$$

with iε[1,m+4], jε[m+5, n+m+4]. This can be transformed into

$${H}_{ij}^{ur} = {\sum }_{k = 0}^{n} {λ}_{k} {h}_{k}^{ur , i , j} , {h}_{kl}^{ur , i , j} = {( ∇ {A}_{k} \frac{\partial W}{\partial {r}_{i}} )}^{T} {A}_{j} . \qquad ( 17 )$$

The Lower Right Quadrant.

This is simply the scalar products of the appearance images. This quadrant is therefore the identity matrix.

Theoretical Gain of Using the Linear Space Inner Product

Table 1 summarizes the time complexity of one iteration of SICIA [?]. The left column is the calculation performed and a reference to the corresponding equation (s). The first row is the computation of the error image including warping of input image and the image composite with a model appearance instance. The second step is the calculation of the steepest descent images and the third row is the scalar product of the steepest descent images and the error image. The fourth and main step is the calculation of the hessian and its inverse.

TABLE 1
Summary of the time complexity for one iteration of SICIA.

| Calculation | SICIA-Original | SICIA-LSIP |
|---|---|---|
| E, ₍₇₎ | O((n + m + 4)N | O((n + m + 4)N |
| SD_{Σ}, ₍₈₎ | O((n + m + 4)N | O((n + m + 4)N |
| SD_{Σ}E, ₍₁₀₎ | O((n + m + 4)N | O((n + m + 4)N |
| H⁻¹, ₍₁₀₎, ₍₁₁₎ | O((n + m + 4)²N + | O((m + 4)²(n/2)² + |
| | (n + m + 4)³) | (n + m + 4)³) |
| Total | O((n + m + 4)²N + | O((m + 4)²(n/2)² + |
| | (n + m)³) | (n + m)³ + |
| | | 4(n + m + 4)N) |

The overwhelmingly largest time consumer for the original SICIA is the construction of the hessian. The computational cost is O((n+m+4)²N) where N is the size of the image. With the LSIP this task is converted to O((m+4)² (n/2)²).

We have described the underlying method used for the present invention together with a list of embodiments. Possible application areas for the above described invention range from object recognition, face recognition, facial expression analysis, object part analysis to image synthesis and computer graphics.

1. A method for efficient computation of the hessian matrix used in image-based model fitting that uses the space defined by the model to pre-compute the image inner products needed to construct this matrix.

2. The method according to claim 1, wherein said model is an active appearance model.

3. The method according to claim 1 wherein said space is a linear space defined by the modes of variation of the model.

4. A method for efficiently locating landmark points in images where the landmark points are obtained through a model fitting according to claim 1.

5. A computer program stored in a computer readable storage medium and executed in a computational unit for efficient computation of the hessian matrix used in image-based model fitting that uses the space defined by the model to pre-compute the image inner products needed to construct this matrix.

6. A system for fitting an image-based model containing a computational unit and a camera, e.g. a computer with camera or a mobile phone, where the image-based model is fitted according to claim 5.

7. A system for efficiently locating landmark points in images where the landmark points are obtained through a model fitting according to claim 6.
